(19) United States
(12) Patent Application Publication
(10) Pub. No.: US 2012/0147862 A1
(43) Pub. Date: Jun. 14, 2012

(54) SYSTEM AND METHOD FOR AUTOMATIC FILTERING OF DEVICE POINT INFORMATION AS A FUNCTION OF WIRELESS ACCESS POINT LOCATION

(75) Inventors: Rajesh V. Poojary, Bangalore (IN); Ajil Roy, Bangalore (IN); Giri Babu Guntipalli, Bangalore (IN)

(73) Assignee: Honeywell International Inc., Morristown, NJ (US)

(21) Appl. No.: 12/963,722

(22) Filed: Dec. 9, 2010

(51) Int. Cl. H04W 84/02

(52) U.S. Cl. 370/338

(57) ABSTRACT

In an embodiment, information relating to a plurality of wireless access points, a plurality of building zone controllers, and a plurality of zones is received into a building management system (BMS) server. Each wireless access point is associated with a particular zone that includes a particular group of building zone controllers. Data relating to a wireless access point with which the personal communication device is in communication is received into the BMS server from a personal communication device. The BMS server automatically transmits to the personal communication device information relating to a plurality of devices located in a first zone. The first zone is associated with the wireless access point with which the personal communication device is in communication.

### TECHNICAL FIELD

The current disclosure relates to wireless networks and wireless communication systems, and in an embodiment, but not by way of limitation, a system and method for automatically filtering device point information as a function of wireless access point location.

### BACKGROUND

In current building management system (BMS) applications and converged building solutions, where multiple utilities of the buildings are integrated into a single system, software in a personal data assistant (PDA) is used by a maintenance/commissioning engineer or operator to connect to a BMS server to view the online values of devices within the BMS and to control the devices during daily maintenance and commissioning activities. However, there are shortcomings with such current systems. The maintenance/commissioning engineer or operator must know the complete details of the points or point names whenever he wants to view the points which belong to a particular zone within the building. It is very difficult and tedious to remember all the point names as most BMS servers are configured with thousands of IO points, at least in the case of converged building solutions. The manual filtering of such points takes a great deal of time and in turn increases the maintenance time of the system. PDA screens are very small with limited display options, so it is very difficult to navigate and filter the points that belong to a specific zone. Due to the network traffic, online tool performance, large databases, and the filtering and navigating mechanisms for those databases, it takes a great deal of time to display manually filtered results. Moreover, if the operator of the BMS is new to the facility, he must first understand the system's connectivity and controller/point names in order to use PDA-based online tools and to filter the point displays as per the zone. Additionally, in industrial applications and process solutions, multiple plants have large numbers of IO points, and manual filtering of the IO points is a tedious job.

### BRIEF DESCRIPTION OF THE DRAWINGS

FIG. 1 is a block diagram of an example embodiment of a building management system communicating with multiple controllers located in different zones.

FIG. 2 is a flowchart of an example embodiment of a process to automatically filter devices, zones, information, and points in a building management system as a function of a nearest wireless access point.

FIGS. 3A and 3B are a flowchart of another example embodiment of a process to automatically filter devices, zones, information, and points in a building management system as a function of a nearest wireless access point.

FIG. 4 is a block diagram of an example embodiment of a computer system in connection with which one or more embodiments of the present disclosure can execute.

### DETAILED DESCRIPTION

Using the concept of a nearest wireless (WiFi) network access point, a filtering of a database of devices can be performed to determine the devices that are within a particular zone within a building and/or are associated with a particular controller. Personal Digital Assistants (PDA) are connected to the Local Area Network (LAN) or the Wide Area Network (WAN) of a building via wireless routers. The area of the building is divided into zones with respect to wireless network access points. The building utilities/zone controllers are mapped to the nearest wireless network access point. A building management server automatically filters the criteria, based on the filter criteria defined in the BMS system, for the online client software of the PDA. Whenever the PDA moves from one zone to another zone, the automated filter mechanism should become activated based on the nearest access point when the PDA acquires network connectivity.

Such a system can include many features. There is a dynamic and automated filtering of wireless network IO points and devices based on a nearest wireless network access point in a PDA/MMI (Machine Man Interface) based client station. Wireless access point details or wireless node details can be defined, and the devices can be grouped based on these wireless access points with respect to a zone. In such a BMS, the status of each router can be received as a PDA-based client transmits the wireless network access point details back to the server. In another embodiment, industrial and process control applications can be monitored in a large number of plants.

One or more embodiments can achieve the following benefits. The productivity of field and maintenance engineers can be increased due to a reduction in the effort required for monitoring the devices locally using PDAs/MMIs. Also, one or more embodiments can be used effectively in industrial and process applications where single plant details are monitored out of multiple plants. An embodiment gives a quick display based on a wireless network point where that plant or device is located.

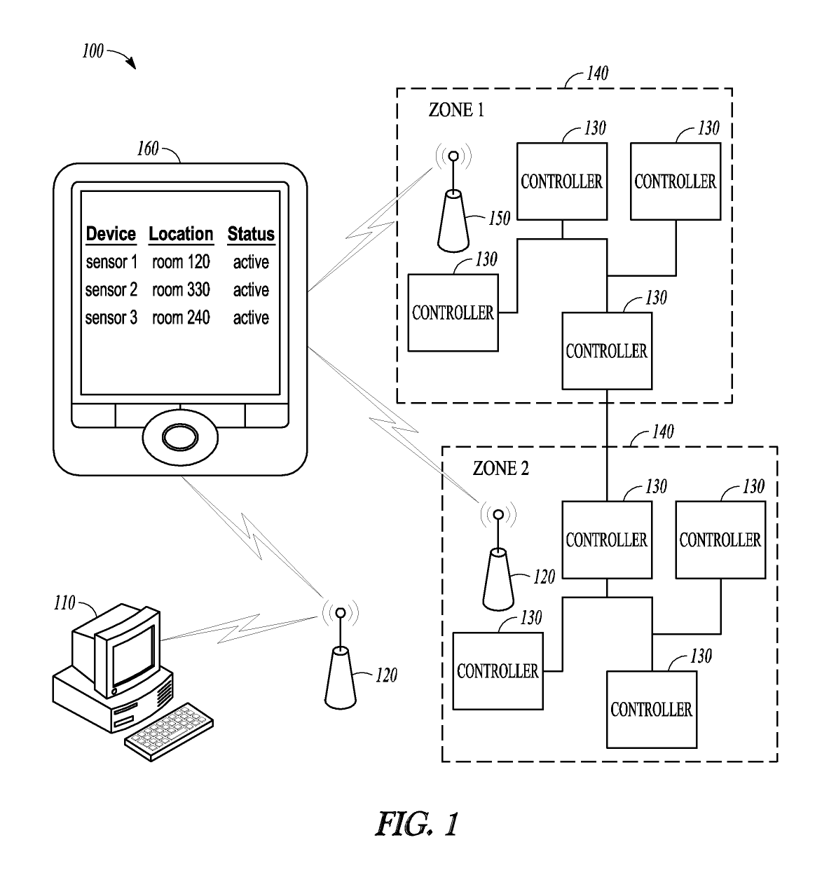

FIG. 1 illustrates an example embodiment of a building management system 100. A BMS server 110 can communicate with one or more wireless routers 120. The system further includes one or more controllers 130, and each controller is associated with a zone 140. More than more controller can be associated with any particular zone. An access point 150 provides access to the zones for a PDA device 160.

The following high level configurations can be supported in a building management server that is used for integrating all the utilities inside a building or in a converged building solution. In the BMS server, the details of the numerous wireless network access points are defined along with the zone information in which a particular network access point is located. The definition should include a host ID or media access control (MAC) address of the wireless router. A group is created with respect to the zone and mapped to the defined wireless network router. In the BMS server, there is filter criteria for a client station based on the wireless network access point of the client location. The PDA/HMI (Human Machine Interface) logs into the BMS network, and it sends its present wireless access point (Wifi router) to the server. Based on the information of the wireless access point, the BMS server returns to the PDA the filtered information relating to the devices that are associated with that access point and zone. Upon change in a PDA location, a new wireless access point is transmitted to the BMS server. The BMS server in return sends out the relevant information of the field devices that are associated with the zone as per the nearest network access point.

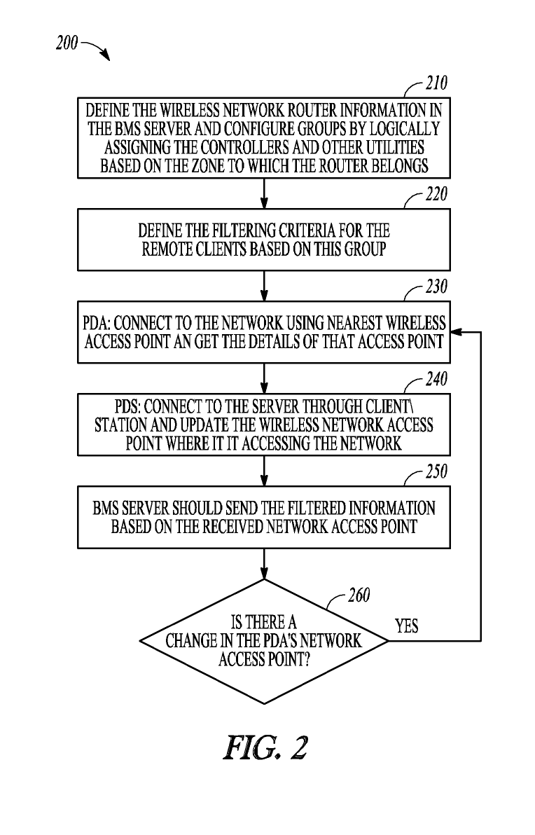

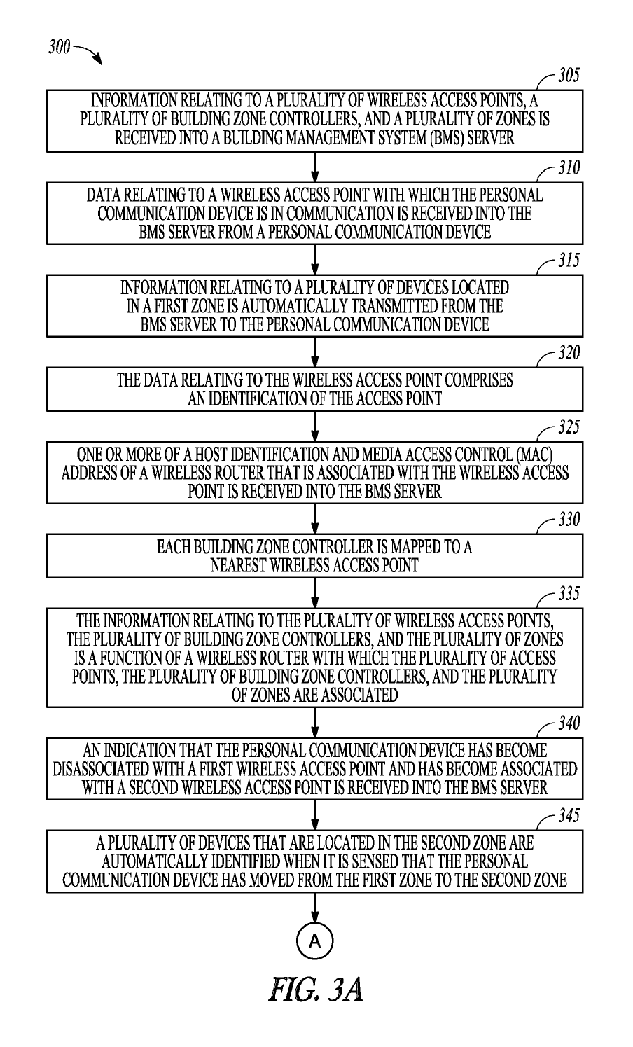

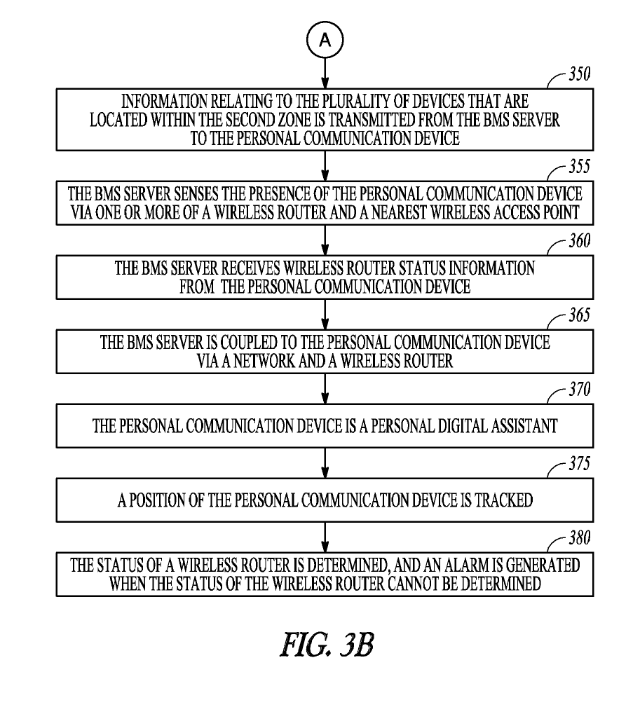

FIGS. 2, 3A, and 3B are flowcharts of example processes 200 and 300 for automatically filtering device point information as a function of wireless access point location. FIGS. 2, 3A, and 3B include a number of process blocks 210-260 and 305-380 respectively. Though arranged serially in the examples of FIGS. 2, 3A, and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

FIG. 2 illustrates an example process 200 to automatically filter the devices of a BMS as a function of a nearest access point. At 210, the wireless network router information is defined in a BMS server. Additionally, groups are configured by logically assigning controllers and other utilities based on the particular zone to which a particular router belongs. At 220, filtering criteria is defined for remote clients based on the groupings. At 230, a PDA connects to the network using a nearest wireless access point, and the PDA acquires the details of that access point. At 240, the PDA connects to the BMS server via a client station, and the PDA updates in the BMS server the access point through which it is accessing the network. At 250, the BMS server transmits to the PDA filtered information based on the network access point that it received from the PDA. At 260, it is determined when there is a change in the PDA's network access point, and when there is, execution is transferred back to block 230.

FIGS. 3A and 3B illustrate another example process 300 to automatically filter the devices of a BMS as a function of a nearest access point. At 305, information relating to a plurality of wireless access points, a plurality of building zone controllers, and a plurality of zones is received into a building management system (BMS) server. Each wireless access point is associated with a particular zone that includes a particular group of building zone controllers. At 310, data relating to a wireless access point with which the personal communication device is in communication is received into the BMS server from a personal communication device. At 315, information relating to a plurality of devices located in a first zone is automatically transmitted from the BMS server to the personal communication device. The first zone is associated with the wireless access point with which the personal communication device is in communication.

At 320, the data relating to the wireless access point comprises an identification of the access point. At 325, one or more of a host identification and media access control (MAC) address of a wireless router that is associated with the wireless access point is received into the BMS server. At 330, each building zone controller is mapped to a nearest wireless access point. At 335, the information relating to the plurality of wireless access points, the plurality of building zone controllers, and the plurality of zones is a function of a wireless router with which the plurality of access points, the plurality of building zone controllers, and the plurality of zones are associated. At 340, an indication that the personal communication device has become disassociated with a first wireless access point and has become associated with a second wireless access point is received into the BMS server. This indicates that the personal communication device has moved from a first zone to a second zone. At 345, a plurality of devices that are located in the second zone are automatically identified when it is sensed that the personal communication device has moved from the first zone to the second zone. At 350, information relating to the plurality of devices that are located within the second zone is transmitted from the BMS server to the personal communication device. At 355, the BMS server senses the presence of the personal communication device via one or more of a wireless router and a nearest wireless access point. At 360, the BMS server receives wireless router status information from the personal communication device. At 365, the BMS server is coupled to the personal communication device via a network and a wireless router. At 370, the personal communication device is a personal digital assistant. At 375, a position of the personal communication device is tracked. At 380, the status of a wireless router is determined, and an alarm is generated when the status of the wireless router cannot be determined.

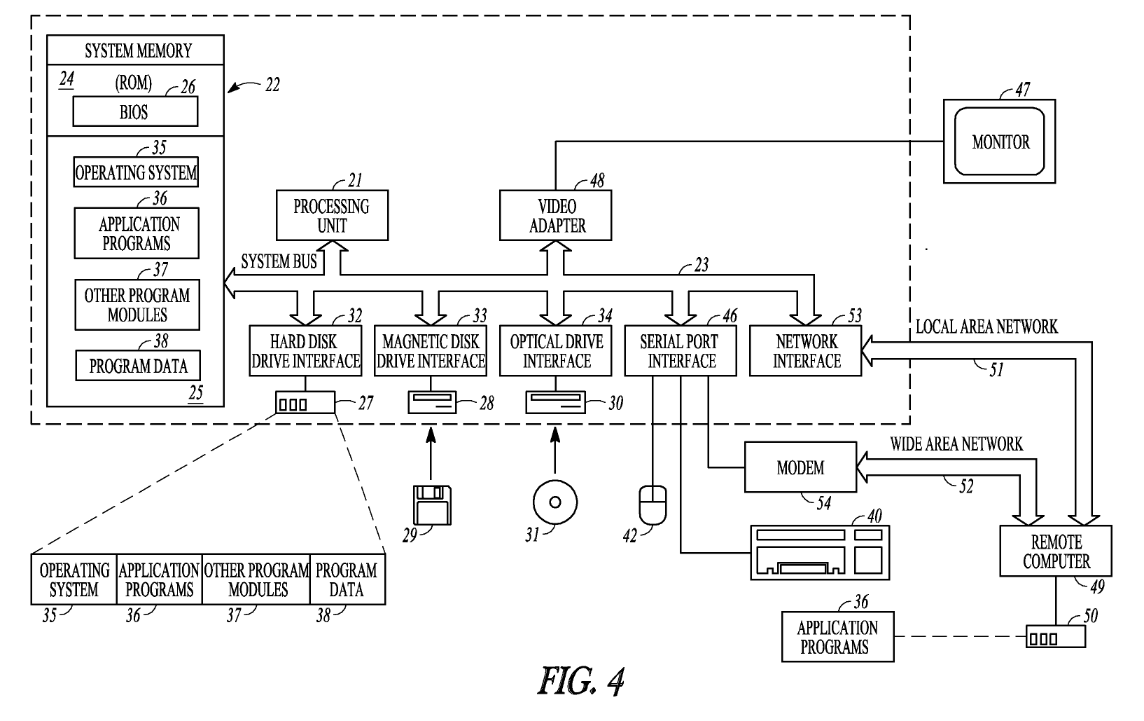

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A process comprising:
receiving into a building management system (BMS) server information relating to a plurality of wireless access points, a plurality of building zone controllers, and a plurality of zones, wherein each wireless access point is associated with a particular zone that includes a particular group of building zone controllers;
receiving into the BMS server, from a personal communication device, data relating to a wireless access point with which the personal communication device is in communication; and
automatically transmitting from the BMS server to the personal communication device information relating to a plurality of devices located in a first zone, wherein the first zone is associated with the wireless access point with which the personal communication device is in communication.

2. The process of claim 1, wherein the data relating to the wireless access point comprises an identification of the access point.

3. The process of claim 1, comprising receiving into the BMS server one or more of a host identification and media access control (MAC) address of a wireless router that is associated with the wireless access point.

4. The process of claim 1, comprising mapping each building zone controller to a nearest available wireless access point.

5. The process of claim 1, wherein the information relating to the plurality of wireless access points, the plurality of building zone controllers, and the plurality of zones is a function of a wireless router with which the plurality of access points, the plurality of building zone controllers, and the plurality of zones are associated.

6. The process of claim 1, comprising receiving into the BMS server an indication that the personal communication device has become disassociated with a first wireless access point and has become associated with a second wireless access point, thereby indicating that the personal communication device has moved from a first zone to a second zone.

7. The process of claim 6, wherein upon sensing that the personal communication device has moved from the first zone to the second zone, automatically identifying a plurality of devices that are located in the second zone.

8. The process of claim 7, comprising transmitting from the BMS server to the personal communication device information relating to the plurality of devices that are located within the second zone.

9. The process of claim 1, wherein the BMS server senses the presence of software in the personal communication device via one or more of a wireless router and a nearest wireless access point.

10. The process of claim 1, wherein the BMS server receives wireless router status information from the personal communication device.

11. The process of claim 1, wherein the BMS server is coupled to the personal communication device via a network and a wireless router.

12. The process of claim 1, wherein the personal communication device is a personal digital assistant.

13. The process of claim 1, comprising tracking a position of the personal communication device.

14. The process of claim 1, comprising:
determining a status of a wireless router; and
generating an alarm when the status of the wireless router cannot be determined.

15. A system comprising:
one or more computer processors configured for:
receiving into a building management system (BMS) server information relating to a plurality of wireless access points, a plurality of building zone controllers, and a plurality of zones, wherein each wireless access point is associated with a particular zone that includes a particular group of building zone controllers;
receiving into the BMS server, from a personal communication device, data relating a wireless access point with which the personal communication device is in communication; and
automatically transmitting from the BMS server to the personal communication device information relating to a plurality of devices located in a first zone, wherein the first zone is associated with the wireless access point with which the personal communication device is in communication.

16. The system of claim 15, comprising a processor configured for receiving into the BMS server an indication that the personal communication device has become disassociated with a first wireless access point and has become associated with a second wireless access point, thereby indicating that the personal communication device has moved from a first zone to a second zone.

17. The system of claim 16, wherein upon sensing that the personal communication device has moved from the first zone to the second zone, automatically identifying a plurality of devices that are located in the second zone.

18. The system of claim 17, comprising a processor configured for transmitting from the BMS server to the personal communication device information relating to the plurality of devices that are located within the second zone.

19. A computer readable medium comprising instructions that when executed by a processor execute a process comprising:
receiving into a building management system (BMS) server information relating to a plurality of wireless access points, a plurality of building zone controllers, and a plurality of zones, wherein each wireless access point is associated with a particular zone that includes a particular group of building zone controllers;
receiving into the BMS server, from a personal communication device, data relating a wireless access point with which the personal communication device is in communication; and
automatically transmitting from the BMS server to the personal communication device information relating to a plurality of devices located in a first zone, wherein the first zone is associated with the wireless access point with which the personal communication device is in communication.

20. The computer readable medium of claim 19, comprising:
instructions for receiving into the BMS server an indication that the personal communication device has become disassociated with a first wireless access point and has become associated with a second wireless access point, thereby indicating that the personal communication device has moved from a first zone to a second zone;
wherein upon sensing that the personal communication device has moved from the first zone to the second zone, automatically identifying a plurality of devices that are located in the second zone; and
comprising transmitting from the BMS server to the personal communication device information relating to the plurality of devices that are located within the second zone.
